(19) United States
(12) Patent Application Publication
(10) Pub. No.: US 2015/0183051 A1
(43) Pub. Date: Jul. 2, 2015

(54) COMPONENT WITH A SANDWICH STRUCTURE AND METHOD FOR PRODUCING IT

(71) Applicant: voestalpine Stahl GmbH, Linz (AT)

(72) Inventors: Andreas Sommer, Crailsheim (DE); Siegfried Kolnberger, Pasching (AT); Thomas Kurz, Linz (AT); Karl Michael Radlmayr, Linz (AT); Martin Rosner, Oed-Öhling (AT)

(21) Appl. No.: 14/419,334

(22) PCT Filed: Jul. 15, 2013
(86) PCT No.: PCT/EP2013/064881

§ 371 Date: Feb. 3, 2015

(30) Foreign Application Priority Data
Aug. 3, 2012 (DE) 10 2012 015 431.3

(51) Int. Cl. B23K 20/02; B32B 15/01

(52) U.S. Cl. CPC B23K 20/02; B32B 15/011; B32B 15/013

(57) ABSTRACT

A method for producing a component with a sandwich structure, in which at least one essentially flat top layer is produced from a ferrous material, a structure is introduced into an essentially flat intermediate layer composed of a ferrous material, contact regions of the intermediate layer are at least partially galvanized, the at least one top layer and the intermediate layer are superposed to form a composite so that the contact regions rest against the top layer, and the composite is then press hardened. The invention produces an easily recyclable component with a sandwich structure, which has good rigidity and strength properties.

### FIELD OF THE INVENTION

The present invention relates to a method for producing a component with a sandwich structure, a method for producing a sandwich material, particularly for use in a method for producing a component with a sandwich structure, and a component with a sandwich structure.

### BACKGROUND OF THE INVENTION

Sandwich structures are generally known from the prior art. A sandwich structure can in general be understood to be a structure that has at least one essentially flat top layer and one intermediate layer that is often provided with a structure. These two layers are joined to each other. Although the mere combination of a top layer with an intermediate layer can be referred to as a sandwich structure, most known sandwich structures have two top layers, between which an intermediate layer is situated. Such a sandwich structure or a material that has this sandwich structure has a number of advantages. On the one hand, this structure has a good ratio of rigidity to weight. In particular, the structure of the intermediate layer produces this favorable rigidity, although only a small amount of material has to be used and in particular, the interstice between the two top layers is not completely filled with material. This also yields a favorable economy of such structures since it is possible to achieve savings in material.

Because of the very advantageous ratio between rigidity and weight, sandwich structures are used in many technology fields. Vehicle manufacturing and aerospace should in particular be mentioned here. In general, however, sandwich structures are primarily used wherever a low weight is required despite a high rigidity or in general a high stability.

DE 10 2009 025 821 A1 has disclosed a method for producing a metal component in which a plate is embossed in some areas and is thus given a structure with embossed and non-embossed regions. This plate can be attached to another plate, in particular a non-embossed plate, which produces air gaps between the two plates that are supposed to have an advantageous effect on the ductility of the component. The two plates can be joined to each other by means of material adhesion, in particular by means of welding, or by means of mutual forming and a resulting positive engagement. In this type of sandwich structure, however, no weight advantage is achieved since the material is only embossed and not removed. Furthermore, embossing is generally a relatively complex and expensive method.

WO 03/047848 A1 has disclosed a composite component, which is composed of two essentially flat top layers and an intermediate layer with a structure. A filling material such as a polymer is introduced into the resulting interstices between the intermediate layer and the top layers. This material should achieve a particularly advantageous absorption capacity in the event of impacts, e.g. in the event of an accident. All three layers are preferably composed of steel and are joined to one another by means of adhesives. Although the object of this reference is an improved recyclability of sandwich structures, this effect is specifically not achieved by the gluing of these individual layers. The filling material also results in a higher weight of the component, which must likewise be viewed as disadvantageous.

JP 06-007865 A has disclosed a component with a sandwich structure in which the component has a curved shape. The individual layers of this component are composed of aluminum, which does in fact facilitate recyclability, but results in the fact that the component produced in this way is extremely expensive.

The presentation “Multi-Laminated Composite Parts Designed by Thermo-Mechanical Forming” by N. Barbakadze et al. disclosed a multi-layered component in which two outer layers composed of steel and one intermediate layer of aluminum. The material is subjected to a press hardening process. During the press hardening process, on the one hand, a diffusion of iron from the steel into its aluminum/silicon coating occurs and on the other hand, a flow of the aluminum of the intermediate layer into the coating occurs, both of which bond the individual layers to one another. A component produced in this way is hardly recyclable since the individual layers, which are composed of different materials, are joined to one another by material adhesion and as a result, these layers can only be separated from one another with difficulty in a recycling process. The use of aluminum must also be viewed as disadvantageous since aluminum is very expensive and consequently, such components can be inexpensively produced only with difficulty. The disclosed method is also extraordinarily complex since the steel layers must first be separately heated because the aluminum of the intermediate layer would melt as it passed through a furnace.

Simple sandwich structures in which, for example, two top layers as well as one structured intermediate layer are composed of steel—which layers must be welded to one another in order to be joined—can hardly be deformed since the individual connection points crack even with slight deformations of the component. Consequently, it is not possible to press harden these components. Without press hardening, however, components produced in this way do not have a sufficient rigidity and/or sufficient strength properties, which is why they are not suitable for use in the sectors mentioned above.

The object of the invention, therefore, is to create a method for producing a recyclable component with a sandwich structure, which has improved rigidity and strength properties compared to sandwich components known from the prior art.

Another object of the invention is to create a sandwich material that has a forming capacity and in particular, a press hardening capacity.

### SUMMARY OF THE INVENTION

The method according to the invention for producing a component with a sandwich structure is composed of the following steps:
production of at least one essentially flat top layer composed of a ferrous material;
introduction of a structure into an essentially flat intermediate layer composed of a ferrous material;
at least partial galvanization of contact regions of the intermediate layer;
superposition of the top layer and the intermediate layer to form a composite so that the contact regions of the intermediate layer rest against a top layer;
press hardening of the composite; and
the component is composed of only ferrous materials, in particular steel, and zinc and in particular, contains no adhesives and/or fillers for filling interstices between the cover layer and the intermediate layer.

### DETAILED DESCRIPTION OF THE PREFERRED EMBODIMENTS

The use of ferrous materials both for the at least one top layer and for the intermediate layer significantly facilitates the recyclability of the component produced according to the invention. In addition, the zinc that is applied in the contact regions of the intermediate layer does not reduce this effect since it is easily possible to recycle galvanized steel components. The galvanizing of contact regions, however, results in the fact that the intermediate layer bonds to the at least one top layer during the press hardening process. In this case, zinc diffuses into both layers and consequently produces a bond. The composite, however, retains the capacity to be formed and thus the capacity to be press hardened since the zinc is soft enough and therefore permits a sliding, so to speak, of the individual layers relative to one another during the forming.

The use of ferrous materials both for the at least one top layer and for the intermediate layer significantly facilitates the recyclability of the component produced according to the invention. In addition, the zinc that is applied in the contact regions of the intermediate layer does not reduce this effect since it is easily possible to recycle galvanized steel components. The galvanizing of contact regions, however, results in the fact that the intermediate layer bonds to the at least one top layer during the press hardening process. In this case, zinc diffuses into both layers and consequently produces a bond. The composite, however, retains the capacity to be formed and thus the capacity to be press hardened since the zinc is soft enough and therefore permits a sliding, so to speak, of the individual layers relative to one another during the forming.

The press hardening process in this case can be produced according to the direct or indirect press hardening process. In the direct press hardening process, a plate, in this case composed of the composite, is heated in a furnace to the austenitization temperature and then simultaneously formed and quench hardened. In the indirect press hardening process, the plate, which is comprised of the composite, is cold formed, then heated in a furnace, and finally quench hardened in a mold. In this case, the bonding of the individual layers by means of zinc diffusion can advantageously occur during the respective heating step in the press hardening. Alternatively or in addition, however, it is also possible to carry out the bonding of the individual layers before the press hardening process, with the composite being heated in subregions, particularly in the regions in which the contact regions of the intermediate layer rest against a top layer.

The composite is advantageously produced in a continuous process, for example with the base material of all three layers being unrolled from a coil and then used in the method according to the invention.

In a particularly advantageous modification of the invention, the at least one top layer is composed of boron/manganese steel, in particular of 22MnB5. Manganese/boron steel and in particular 22MnB5 has particularly good press hardening capacity and has outstandingly favorable strength and rigidity properties.

In order to achieve further weight savings and thus obtain an even better ratio between rigidity and weight, in an advantageous modification of the method according to the invention, the intermediate layer has a woven and/or meshwork and/or expanded metal and/or is composed of this. Through the structuring of the intermediate layer, even materials of this kind are suitable for use in the method according to the invention and the overall weight of the component can be further reduced.

With an advantageous modification of the invention, the structure that is introduced into the intermediate layer is a structure that is periodic in at least one direction. This enables a particularly simple and therefore economical production of the structure since it can be easily introduced into the intermediate layer in a continuous process.

In an advantageous modification of the invention, the structure has structural elements that are introduced into the intermediate layer. The structural elements can advantageously be introduced by means of a die and then correspondingly have a basic form that corresponds to that of the die. Possible basic forms for this include in particular polygons and trapezoids, circles, and honeycombs. The advantage achieved by means of this lies in the fact that the contact regions in which the intermediate layer rests against a top layer are enlarged. The larger these regions are, the more pronounced the bonding is between the intermediate layer and a top layer.

Whereas the embodiments of the invention are usually spoken of as an intermediate layer and one or two top layers, the invention can also involve a component or a material with more layers. For example, it would be possible for a component with a sandwich structure to have two intermediate layers and three top layers, with the layers arranged in alternating fashion. It is also possible for such a component or the sandwich material on which it is based, as well as other embodiments with different numbers of top and/or intermediate layers, to be produced by means of the method according to the invention.

In an advantageous modification of the invention, a material with a thickness of d≦1.0 mm, in particular d≦0.5 mm, can be used for the top layer. It has turned out that top layers with such a slight thickness are sufficient to give the composite a good rigidity and strength.

Through the use of ferrous materials, particularly in the top layer, it is also possible to provide the top layer with a corrosion protection with the method according to the invention. A galvanization of the top layer has turned out to be particularly advantageous here. In this case, the corrosion protection does not necessarily have to be applied in subregions, e.g. only on the side of the top layer that is not bonded to the intermediate layer. Instead, the top layer can be provided with a corrosion protection over its entire surface.

The contact regions of the intermediate layer that are galvanized are advantageously extreme points of the intermediate layer since as a rule, these are the points that come into contact with a top layer. At these extreme points, the intermediate layer has a large deviation from its original shape. If structural elements that have a flat basic shape are introduced into the intermediate layer, then these surfaces must be understood as a collection of extreme points that are therefore preferably galvanized over their entire area. In this case, the galvanization of the intermediate layer and possibly of the top layers is in particular carried out before the composite is produced.

In an advantageous modification of the method according to the invention, before the press hardening, the at least one top layer and the intermediate layer are bonded, in particular soldered and/or welded, in at least a part of the contact regions. This joining by material adhesion primarily serves to achieve a certain basic stability during the transport of the composite into the press hardening tool and/or the furnace in which the component is heated as part of the press hardening process. It is quite possible that these attachments through material adhesion will crack during the press hardening process and particularly during the forming, but this is secondary since the attachment of the individual layers is essentially produced by the zinc diffusion.

In order to simplify the recycling of the component produced according to the invention as much as possible, in advantageous modifications of the method according to the invention, only ferrous materials, in particular steel, and zinc are used in the production of the component. Consequently, in these modifications, neither adhesives nor plastics such as fiber composite materials and likewise no aluminum are used, which makes the component extremely easy to recycle.

The method according to the invention for producing a sandwich material, in particular for use in a method according to one of the preceding embodiments, has the following steps:
production of at least one essentially flat top layer composed of a ferrous material;
introduction of a structure into an essentially flat intermediate layer composed of a ferrous material;
at least partial galvanization of at least contact regions of the intermediate layer;
superposition of the top layer and the intermediate layer to form a composite so that the contact regions rest against the top layer; and
heating of the composite in at least some regions, particularly in the contact regions.

This method is essentially similar to the method according to the invention for producing a component with a sandwich structure, but is primarily aimed only at the sandwich material on which the component with a sandwich structure is based. This sandwich material can be used, among other things, in the method according to the invention for producing a component with a sandwich structure; then, according to the invention, the only thing that must occur is a press hardening of the composite. The sandwich material produced according to the invention is thus suitable for further use in other production processes. Since the sandwich material in the method according to the invention is not absolutely subjected to a hardening treatment, the bonding of the individual layers of the sandwich material is achieved in that the composite is heated in subregions. This can advantageously be achieved by means of an induction treatment of the composite or in another way. This heating causes the zinc in the contact regions to diffuse into the top layer that is resting against it, thus producing a connection between the two layers.

The method according to the invention for producing a sandwich material is also advantageously carried out in a continuous process; the sandwich material produced is advantageously cut into plates or wound onto a coil at the end of the production process. It is thus easily possible to transport and further process the sandwich material produced according to the invention.

In an advantageous modification of the method according to the invention for producing a sandwich material, the sandwich material is dressed and/or the at least one top layer and the intermediate layer are additionally bonded, in particular welded. It has turned out that the sandwich material can also be dressed and thus the same advantageous effects of the dressing can be achieved as is the case in conventional, single-layer plates. The additional bonding of the top layer and intermediate layer primarily serves to provide an additional safety in transport.

The method according to the invention for producing a sandwich material can in particular be modified in the same way as the method for producing a component with a sandwich structure. In particular, the statements regarding the materials used, the design of the structure in the intermediate layer, and regarding the corrosion protection of the top layer can be correspondingly used as advantageous modifications to the method according to the invention for producing a sandwich material.

The component according to the invention with a sandwich structure has a three-dimensional form with at least a top layer composed of a ferrous material and an intermediate layer composed of a ferrous material, where the intermediate layer has a structure. The component according to the invention is in particular characterized in that the at least one top layer is attached to the intermediate layer by means of zinc diffusion. It has turned out that even the bonding by means of zinc diffusion produces a sufficient bond between the individual layers of the component with a sandwich structure.

It is easily possible to further process the component according to the invention. For example, the component can be painted or coated in some other way. It is also possible to provide it with inserts of reinforcing devices and/or to provide it with holes by means of which the component can be fastened. The component according to the invention is advantageously press hardened. As part of a further processing, it is possible for subregions of the component to be annealed in order to achieve a non-homogeneous distribution of the strength and rigidity properties in the component. It is also possible for a press hardening to be carried out only in subregions.

In order for the component according to the invention to be as recyclable as possible, it is only composed of ferrous materials, in particular steel, and zinc. In particular, there are no adhesives, fillers for filling interstices between the top layer and intermediate layer, plastics, or aluminum. This makes the component particularly easy to recycle.

The methods according to the invention thus produce a sandwich material and a component with a sandwich structure that are both easy to recycle and at the same time, meet strict requirements with regard to the strength, corrosion protection, surface properties, and the ratio of stability to weight. With the method according to the invention, it is not necessary to produce a marriage, i.e. a bonding, of the individual layers after the heating as part of the press hardening process, since all of the materials are able to withstand the temperatures produced in it and the individual layers can thus be already bonded to one another before a heating step as part of the press hardening process.

1. A method for producing a component with a sandwich structure, comprising the following steps:
producing at least one essentially flat top layer composed of a ferrous material;
introducing a structure into an essentially flat intermediate layer composed of a ferrous material;
at least partially galvanizing contact regions of the intermediate layer;
superimposing the top layer and the intermediate layer to form a composite so that the contact regions rest against the top layer; and
press hardening the composite;
wherein the component is composed of only ferrous materials, in particular steel, and zinc, and contains no adhesives and/or fillers for filling interstices between the cover layer and the intermediate layer.

2. The method according to claim 1, wherein the at least one top layer is composed of boron/manganese steel, in particular 22MnB5.

3. The method according to claim 1, wherein the intermediate layer comprises at least one of the group consisting of a woven, a meshwork, and an expanded metal.

4. The method according to claim 1, wherein the structure is a structure that is periodic in at least one direction.

5. The method according to claim 1, wherein the structure has comprises structural elements that are introduced into the intermediate layer.

6. The method according to claim 1, wherein the at least one top layer has a thickness d≦1.0 mm.

7. The method according to claim 1, wherein the top layer is provided with a corrosion protection.

8. The method according to claim 1, wherein the top layer is galvanized.

9. The method according to claim 1, wherein the galvanization of subregions of the intermediate layer is carried out in contact regions around extreme points of the intermediate layer.

10. The method according to claim 1, wherein before the press hardening, the at least one top layer and the intermediate layer are bonded, in particular soldered and/or welded, in at least a part of the contact regions.

11. The method according to claim 1, comprising using only ferrous materials, in particular steel, and zinc in the production of the component.

12. (canceled)

13. (canceled)

14. A component with a sandwich structure and a three-dimensional form, comprising at least one top layer composed of a ferrous material and an intermediate layer composed of a ferrous material, with the intermediate layer having a structure, wherein the at least one top layer is bonded to the intermediate layer zinc diffusion and the component is composed of only ferrous materials, in particular steel, and zinc, and contains no adhesives and/or fillers for filling interstices between the top layer and the intermediate layer.

15. (canceled)
